(19) United States
(12) Patent Application Publication
(10) Pub. No.: US 2026/0032532 A1
(43) Pub. Date: Jan. 29, 2026

(54) HANDOVER ASSOCIATED WITH TRAFFIC PATTERNS

(71) Applicant: InterDigital Patent Holdings, Inc., Wilmington, DE (US)

(72) Inventors: Magurawalage Chathura Madhusanka Sarathchandra, London (GB); Michael Starsinic, Newtown, PA (US); Rocco Di Girolamo, Laval (CA); Jaya Rao, Montreal (CA); Xavier De Foy, Kirkland (CA); Achref Methenni, Montreal (CA); Michelle Perras, Montreal (CA); Samir Ferdi, Kirkland (CA); Saad Ahmad, Montreal (CA)

(73) Assignee: InterDigital Patent Holdings, Inc., Wilmington, DE (US)

(21) Appl. No.: 18/993,546

(22) PCT Filed: Jul. 11, 2023
(86) PCT No.: PCT/US2023/027345

§ 371 Date: Jan. 11, 2025

Related U.S. Application Data
(60) Provisional application No. 63/359,935, filed on Jul. 11, 2022.

(51) Int. Cl. H04W 36/00; H04W 36/24; H04W 36/30

(52) U.S. Cl. CPC H04W 36/0072; H04W 36/249; H04W 36/30

(57) ABSTRACT

Described herein are systems, methods and instrumentalities associated with performing a handover. A wireless transmit/receive unit (WTRU) as described herein may determine a traffic pattern associated with uplink traffic or downlink traffic. The traffic pattern may indicate at least one of a timing or a priority of the uplink traffic or downlink traffic. The WTRU may send an indication of the traffic pattern to a network device and receive a message from the network device that may indicate a manner for performing a handover. The WTRU may perform the handover in the manner indicated by the message received from the network device, wherein the handover may be performed in coordination with the timing or priority of the uplink traffic or downlink traffic.

### CROSS-REFERENCE TO RELATED APPLICATIONS

This application claims the benefit of Provisional U.S. Patent Application No. 63/359,935, filed Jul. 11, 2022, the disclosure of which is incorporated herein by reference in its entirety.

### BACKGROUND

Handover procedures may disrupts uplink and/or downlink communications. The disruption may affect a user's experience (e.g., reduction in quality of service (QoS) and/or quality of experience (QoE)). It may be desirable to minimize or reduce the disruption.

### SUMMARY

Described herein are systems, methods, and instrumentalities associated with performing a handover. A wireless transmit/receive unit (WTRU) as described herein may be configured to determine a traffic pattern associated with the WTRU, wherein the traffic pattern is associated with uplink traffic or downlink traffic, and wherein the traffic pattern may indicate at least one of a timing or a priority of the uplink traffic or the downlink traffic. The WTRU may send an indication of the traffic pattern to a network device and receive a message from the network device that may indicate a manner (e.g., time, trigger, condition, constraint, etc.) for performing a handover. The WTRU may perform the handover in the manner indicated by the message received from the network device, wherein the handover may be performed in accordance with the timing or priority of the uplink traffic or downlink traffic.

In examples, the indication of the traffic pattern may indicate a priority of application data to be transmitted or received by the WTRU, and the message received from the network device may indicate that the handover may be performed before transmission or reception of the application data. In examples, the message received from the network device may indicate that the handover may be performed before or after transmission of a protocol data unit (PDU) that may be associated with a marker included in a header of the PDU, or after reception of a PDU that may be associated with the marker.

In examples, the indication of the traffic pattern may indicate a periodicity of application data to be transmitted or received by the WTRU, and the message received from the network device may indicate that the handover may be performed during a specific time interval associated with the application data, such as, e.g., during a transmission or reception gap associated with the application data.

In examples, the message received from the network device may indicate that the handover may be performed after the transmission or reception of a specific amount of application data. In examples, the traffic pattern may be associated with a multi-modal or extended reality application associated with the WTRU. In examples, the WTRU may receive configuration information from the network device that may indicate that the WTRU may determine the traffic pattern with respect to one or more of a traffic type, an application, a multi-modal or extended reality session, or a quality of service rule.

A network device as described herein may be configured to transmit configuration information to a WTRU, wherein the configuration information may include an indication for the WTRU to perform traffic pattern detection. The network device may be further configured to receive a report from the WTRU, wherein the report may indicate a traffic pattern detected at the WTRU, and determine, based on the received traffic pattern, a manner (e.g., time, trigger, condition, constraint, etc.) for the WTRU to perform a handover. The network device may transmit a message to the WTRU, wherein the message may indicate the manner for the WTRU to perform the handover.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a diagram illustrating an example of an inter-base station handover.

FIG. 3 is a diagram illustrating examples of handover (HO) procedures.

FIG. 4 is a diagram illustrating an example technique for enhancing handover procedures.

FIG. 5 is a diagram illustrating an example of receiving traffic pattern information for performing a handover.

FIG. 6 is a diagram illustrating an example of receiving traffic pattern information for performing a handover.

FIG. 7 is a diagram illustrating an example of performing a handover based on extended reality (XR) traffic patterns.

FIG. 8 is a diagram illustrating an example of performing a conditional handover based on XR traffic patterns.

FIG. 9 is a diagram illustrating an example of selecting a handover type.

### DETAILED DESCRIPITION

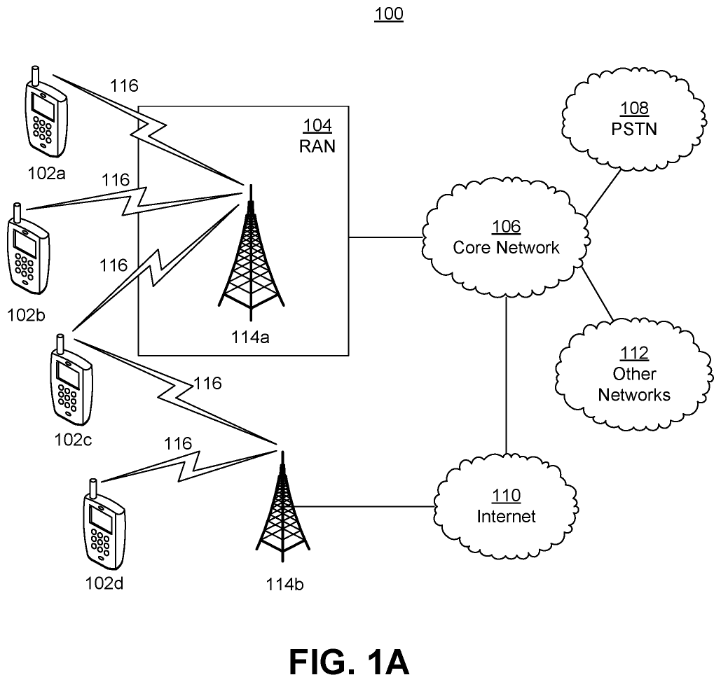

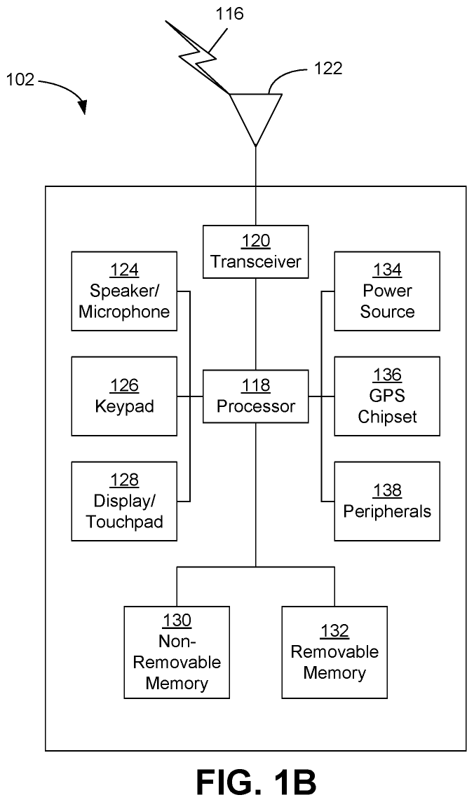

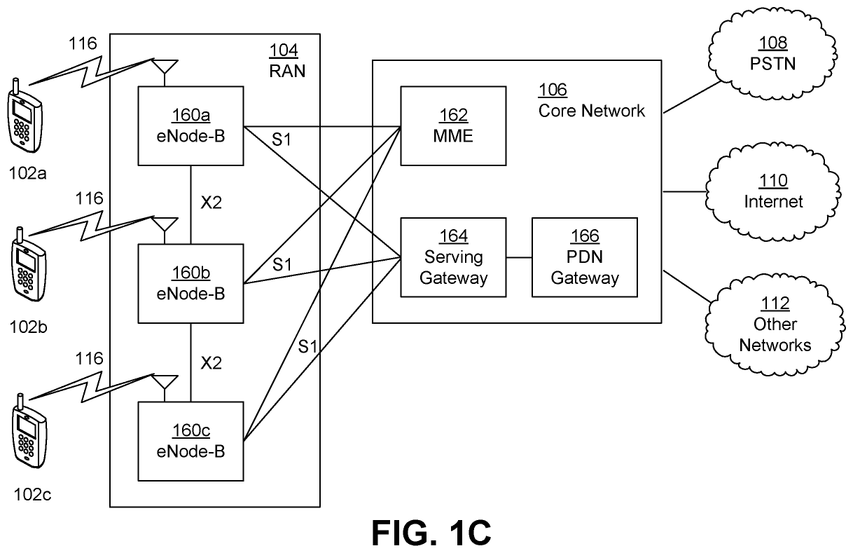

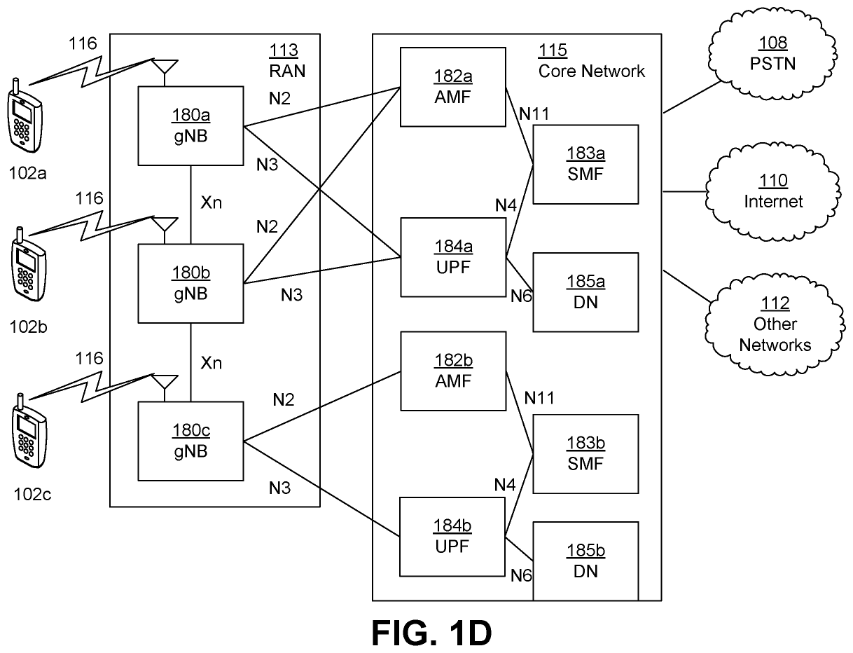

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (WTRU), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c, and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B (eNB), a Home Node B, a Home eNode B, a gNode B (base station), a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a base station).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like.

The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location- determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements is depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHz, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHZ, 2 MHZ, 4 MHZ, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include base stations 180a, 180b, 180c, though it will be appreciated that the RAN 113 may include any number of base stations while remaining consistent with an embodiment. The base stations 180a, 180b, 180c may each include one or more transceivers for communicating with the WTRUs 102a, 102b, 102c over the air interface 116. In one embodiment, the base stations 180a, 180b, 180c may implement MIMO technology. For example, base stations 180a, 108b may utilize beamforming to transmit signals to and/or receive signals from the base stations 180a, 180b, 180c. Thus, the base station 180a, for example, may use multiple antennas to transmit wireless signals to, and/or receive wireless signals from, the WTRU 102a. In an embodiment, the base stations 180a, 180b, 180c may implement carrier aggregation technology. For example, the base station 180a may transmit multiple component carriers to the WTRU 102a (not shown). A subset of these component carriers may be on unlicensed spectrum while the remaining component carriers may be on licensed spectrum. In an embodiment, the base stations 180a, 180b, 180c may implement Coordinated Multi-Point (COMP) technology. For example, WTRU 102a may receive coordinated transmissions from base station 180a and base station 180b (and/or base station 180c).

The WTRUs 102a, 102b, 102c may communicate with base stations 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with base stations 180a, 180b, 180c using subframe or transmission time intervals (TTIs) of various or scalable lengths (e.g., containing varying number of OFDM symbols and/or lasting varying lengths of absolute time).

The base stations 180a, 180b, 180c may be configured to communicate with the WTRUs 102a, 102b, 102c in a standalone configuration and/or a non-standalone configuration. In the standalone configuration, WTRUs 102a, 102b, 102c may communicate with base stations 180a, 180b, 180c without also accessing other RANs (e.g., such as eNode-Bs 160a, 160b, 160c). In the standalone configuration, WTRUs 102a, 102b, 102c may utilize one or more of base stations 180a, 180b, 180c as a mobility anchor point. In the standalone configuration, WTRUs 102a, 102b, 102c may communicate with base stations 180a, 180b, 180c using signals in an unlicensed band. In a non-standalone configuration WTRUs 102a, 102b, 102c may communicate with/connect to base stations 180a, 180b, 180c while also communicating with/connecting to another RAN such as eNode-Bs 160a, 160b, 160c. For example, WTRUs 102a, 102b, 102c may implement DC principles to communicate with one or more base stations 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and base stations 180a, 180b, 180c may provide additional coverage and/or throughput for servicing WTRUs 102a, 102b, 102c.

Each of the base stations 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the base stations 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the base stations 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the base stations 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, base station 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A protocol data unit (PDU) set may comprise one or more PDUs that may carry the payload of a unit of information, for example, generated at an application level (e.g., a frame or video slice for extended reality & media (XRM) services). Multiple PDUs may be associated with the same or similar requirements at an application layer. The application layer may use all or a subset of the PDUs in a PDU set (e.g., use corresponding unit(s) of information carried by the PDUs). In some cases, the application layer may recover part of the information, for example, if some PDUs are missing.

A multi-modal synchronization threshold may be defined, for example, as the maximum tolerable temporal separation of the onset of two stimuli (e.g., one stimulus may be presented to one sense and the other stimulus may be presented to another sense), such that sensory objects accompanying the stimuli may be perceived as being synchronous. When used herein, a synchronization threshold may refer to a tolerable (e.g., the maximum tolerable) temporal separation between the transmission or reception of two flows. Further, when used herein (e.g., in the context of a PDU set), a unit of information may refer to application layer unit of information. The terms “unit of information” and “application layer unit of information” may be used interchangeably herein. The terms “application server” and “application function” may also be used interchangeably herein.

Multi-modal data may refer to input data from different types of devices and/or sensors, or output data associated with different destinations (e.g., multiple WTRUs) that may be involved with the same task or application. Multi-modal data may include data associated with more than one modality (e.g., multi-modal data may include multiple sets of single-modal data), and there may be a dependency between multiple sets of single-modal data. Single-modal data may be considered as one type of data.

A device or sensor that generates (e.g., sends) single-modal data may be a WTRU or may use a WTRU to send the single-modal data to a network. The single-modal data may be sent to applications that may be hosted on other WTRUs, or to applications that may be hosted on network servers. A device or sensor that receives single-modal data may be a WTRU or may use a WTRU to receive the single-modal data from a network. The single-modal data may be received from applications that may be hosted on other WTRUs, or from applications that may be hosted on network servers. When referred to herein, single-modal data may correspond to a data flow to and/or from a WTRU. When referred to herein, multi-modal data may correspond to multiple data flows to and/or from multiple WTRUs.

A multi-modal data set may be a set of single-modal data flows that may be used for the same task or application. For example, a multi-modal data set may include IP flows and/or QoS flows between a WTRU (e.g., one or more WTRUs) and an application server (e.g., a single application server). The IP flows may carry sensor data, video information, haptic data, audio data, etc.

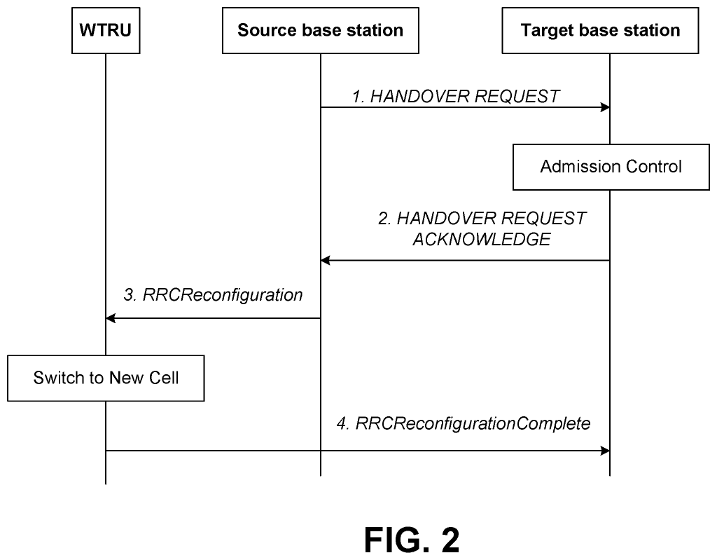

Handover procedures may be controlled by a network and/or may be categorized based on different mobility types (e.g., two types of mobility), such as cell level mobility and beam level mobility. Cell level mobility may be triggered by explicit RRC signaling. As shown in FIG. 2, cell level mobility may involve an inter-base station (e.g., inter-gNB) handover. In such an inter-base station handover, a source base station may initiate the handover and issue a handover request over an Xn Interface to a target base station. The target base may perform an admission control procedure and provide an RRC configuration (e.g., a new RRC configuration) in response to the handover request from the source base station. The source base station may send a message (e.g., an RRCReconfiguration message) to the WTRU. The message may include at least a cell ID and/or information for accessing the target cell (e.g., beam specific information). The WTRU may perform the handover and may send a message (e.g., an RRCReconfigurationComplete message) to the target base station regarding the handover.

In example handover procedures (e.g., intra-NR RAN handover procedures), messages may be directly exchanged between base stations via the Xn interface, e.g., for transferring the WTRU context from a source base station to a target base station. Resources at the source base station may be released once a handover completion phase is triggered by the target base station.

In examples (e.g., in conventional handover procedures), a WTRU may release a connection to a source cell (e.g., the WTRU may terminate uplink and downlink transmissions associated with the source cell) before establishing connectivity to a target cell. This may cause an interruption to services (e.g., in the range of a few tens of milliseconds such as around 30-60 milliseconds). To address this issue, a dual active protocol stack (DAPS) may be implemented. During a handover, the DAPS may allow the WTRU to establish connectivity to both source and target cells (e.g., source and target primary cells (PCells), for example, simultaneously for a short period of time. This may allow the connectivity to the source cell to remain active for the reception and transmission of user data, until data may be sent and received in the target cell. Once the handover is complete, the uplink transmission of user data may be switched to the target cell (e.g., at the completion of a random access procedure). For the source and/or target cells, a common PDCP entity may be configured and PDCP sequence number continuation may be maintained, e.g., to enable in-sequence delivery of user data. Downlink user data may be forwarded from the source cell (e.g., for transmitting to the WTRU until the handover is complete) to the target cell (e.g., buffered for transmitting to the WTRU once the handover is complete) in parallel. Once the handover is complete, uplink user data may be switched from the source cell to the target cell. The source cell may stop transmitting data in the downlink if the target cell informs the source cell of a successful handover. If the handover fails, the WTRU may fall back to the source cell.

A conditional handover (CHO) may refer to a handover procedure that may be executed by a WTRU based on a CHO configuration received from a network. A CHO may aim at reducing failures, e.g., when the user is on the move. Based on a CHO configuration, the WTRU may perform a handover if one or more conditions defined for the handover are met. Once the CHO configuration is received by the WTRU, it may start evaluating the execution conditions for a handover, and may stop evaluating the execution conditions if the handover is executed. A CHO may prepare multiple candidate target cells (e.g., instead of one target cell). This may allow a handover message (e.g., command) to be sent to the WTRU when radio configurations are still good. This may also reduce potential handover failures that may occur due to bad radio conditions, as in legacy handover procedures.

A CHO configuration may indicate one or more candidate cells and/or one or more execution conditions that may be generated by a source base station. The execution conditions may include one or more (e.g., two) trigger conditions (e.g., based on synchronization signal block (SSB) and/or channel state information-reference signal (CSI-RS) measurements).

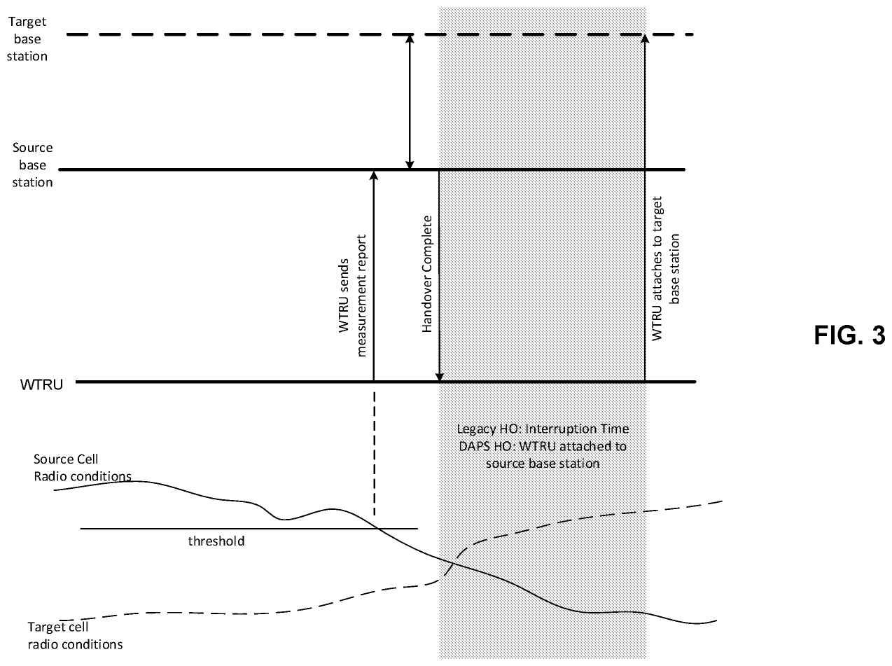

FIG. 3 shows examples of handover (HO) procedures such as a legacy HO procedure and a DAPS-based HO. For the legacy HO, the grey area in FIG. 3 may show an interruption time (e.g., no uplink or downlink traffic may be transmitted over this time). For the DAPS HO, the grey area in FIG. 3 may show a time during which the WTRU may try to attach to a target base station while remain attached to a source base station. During this time, the source base station may forward packets to the target base station, where they may be buffered (e.g., waiting for the WTRU to attach). During this time, the radio quality over the source base station may be poor. Although not shown in FIG. 3, a conditional HO may also suffer from an interruption time.

A user may use a multi-modal application in various (e.g., two) scenarios, for example, while the user is mobile. In a first scenario, the user may use a single WTRU to receive multi-modal streams (e.g., receive all streams on a mobile device). In a second scenario, the user may use multiple WTRUs to consume the same application (e.g., headphones for audio, a haptic suit for haptic, VR glasses for video, etc.). As the user moves (e.g., in a vehicle or walking) from one location to another, the user's connection may be handed over from a first cell to a second cell. Downlink and/or uplink data may be delayed during the handover. The delay (e.g., for XRM data that may be sensitive to delays, jitters, and/or synchronization issues) may lead to a perception of data interruption or low quality of experience.

During a handover, there may be a period of time when uplink and/or downlink data may be delayed. As a result, XRM services may be disrupted until the handover procedure is completed. Multi-modal communication may involve the transmission of data with varying requirements-some may be more stringent than others (e.g., latency requirements for haptic data may be more stringent than video and audio data). Violation of these requirements (e.g., for one type of data) may affect the overall application experience for a user (e.g., reduction in QoS and QoE). Therefore, it may be desirable to reduce or minimize the disruption associated with a handover (e.g., when performing the handover for WTRUs associated with multi-modal sessions).

A WTRU may perform measurements on various physical layer parameters (e.g., SSB and/or CSI-RS), for example, to determine the quality of a cell. These measurements may be used by the WTRU and/or the network to determine whether to perform a handover. A handover may be triggered by a source base station, e.g., by sending a handover message (e.g., an RRCReconfiguration message) to the WTRU. The handover message may specify one or more triggering conditions for performing the handover. If the triggering conditions for performing the handover are met (e.g., if a measurement of a CSI-RS from a source cell is below a threshold and/or if a measurement of a CSI-RS from a target cell is above a threshold), the WTRU may synchronize to the target cell and may complete the RRC handover procedure, for example, by sending a complete indication (e.g., an RRCReconfigurationComplete message) to the target base station. The network may not consider what uplink and/or downlink user plane activities (e.g., procedures) may be taking place or may soon take place when determining a time for initiating the handover procedure. This approach may cause delays during the handover process. To avoid these delays and/or other handover related isseus, handover procedures may be performed between data bursts or during data bursts that may be less important (e.g., data bursts of a low priority). Parameters as associated with traffic patterns or traffic characteristics (e.g., the periodic nature of uplink and/or downlink traffic), the level of importance (e.g., priority) of a set of data (e.g., some video frames may be more important than others) within a flow (e.g., a single-modal flow), and/or the respective levels of importance of data flows (e.g., multiple single-modal flows) of a multi-modal session (e.g., audio flows may be more important than haptic flows) may be considered when determining whether and/or when to start a handover. Taking more than just the cell quality into consideration when determining whether and/or when to perform a handover may allow a communication system to minimize disruptions to a user's application experience. Have a plan for when to initiate a handover may result in less data being delayed and/or dropped at an application layer.

A WTRU may be associated with multiple data radio bearers. A data radio bearer (DRB) may be associated with traffic from one or multiple service data flows (SDFs). If an SDF carries XRM traffic, then the traffic carried over a DRB may be associated with different requirements (e.g., in terms of latency and reliability). For example, some traffic may require both low latency and high reliability. Existing handover mechanisms may not be able to meet these requirements, as they may suffer from handover failures, interruption times, and/or poor radio conditions (e.g., prior to the WTRU attaching to a target base station, as the WTRU may be communicating over a source cell during this time).

A handover may be handled at different levels, such as, e.g., at a packet level, PDU set level, PDU group (e.g., coordination group) level, and/or data flow level. When deciding to handover and/or evaluating conditions for the handover, a WTRU or network may consider the handover of wireless connectivity and/or how the handover may impact the higher layer (e.g., application layer) experience of a user. The handover may be performed according to an assigned priority. For example, high priority flows, PDU groups, and/or PDU sets or packets (or a combination thereof) may be handed over first from a source base station to a target base station, before low priority flows, PDU groups, and/or PDU sets or packets may be handed over. Such a procedure may be different than a handover procedure that only considers conditions at a connectivity layer (e.g., the latter procedure may involve tearing down connectivity to the source base station, establishing new connectivity to the target base station, and handing over the uplink and/or downlink to the target base station). The handover techniques described herein may consider any combination of data flows, PDU groups, PDU sets, and/or packets that the WTRU may be sending or receiving or may soon be sending or receiving, alongside conditions at a connectivity layer. Traffic may be transferred from source and target base stations in parallel.

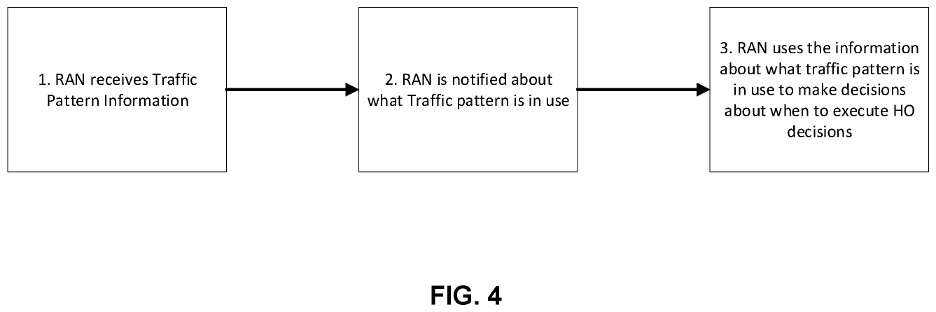

FIG. 4 illustrates examples of operations that may be associated with a handover procedure. As shown in FIG. 4, the operations may include transmitting information regarding a traffic pattern (e.g., detected or determined by a WTRU) to a network device (e.g., an RAN device), with which the network device may determine the traffic pattern experienced by the WTRU. Based on such a traffic pattern, the network device may determine a manner for the network device and/or the WTRU to perform a handover, and may send a message to the WTRU to indicate the manner. The manner may be determined, for example, based on a priority, timing, and/or other characteristics of uplink or downlink application data (e.g., XR application data) associated with the WTRU (e.g., as indicated by the traffic pattern determined and/or reported by the WTRU). The manner may indicate, for example, a time, trigger, constraint, and/or condition for the WTRU to perform the handover. Such a time, trigger, constraint, and/or condition may be coordinated with the priority, timing, and characteristics of the application data associated with the WTRU. For instance, the manner may indicate that the WTRU should perform the handover before transmission or reception of prioritized application data (e.g., application data with a certain priority). The manner may also indicate that the WTRU should perform the handover before or after transmission of a protocol data unit (PDU) that may be associated with a marker (e.g., a certain label or identifier indicative of a priority or importance of the PDU), or after reception of a PDU that may be associated with the marker. The manner may also indicate the WTRU should perform the handover during a specific time interval associated with application data (e.g., during a transmission or reception gap associated with the application data). The manner may also indicate that the WTRU should perform the handover after a specific amount of application data has been transmitted or received by the WTRU. The manner may also indicate the WTRU should perform the handover before or after the transmission or reception of a certain type of application data (e.g., video data, audio data, haptic data, etc.).

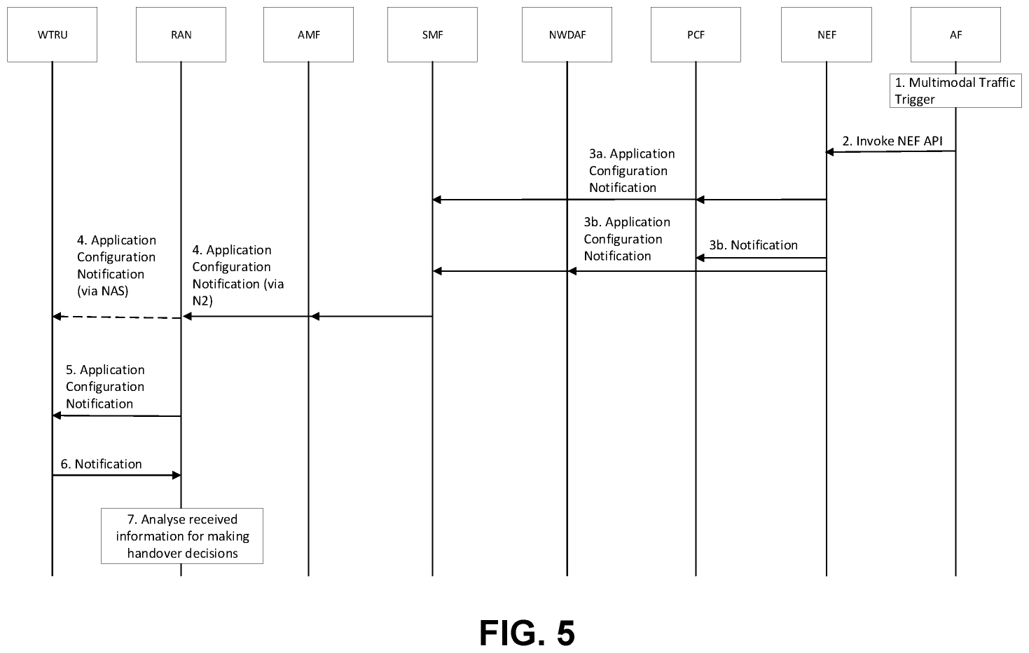

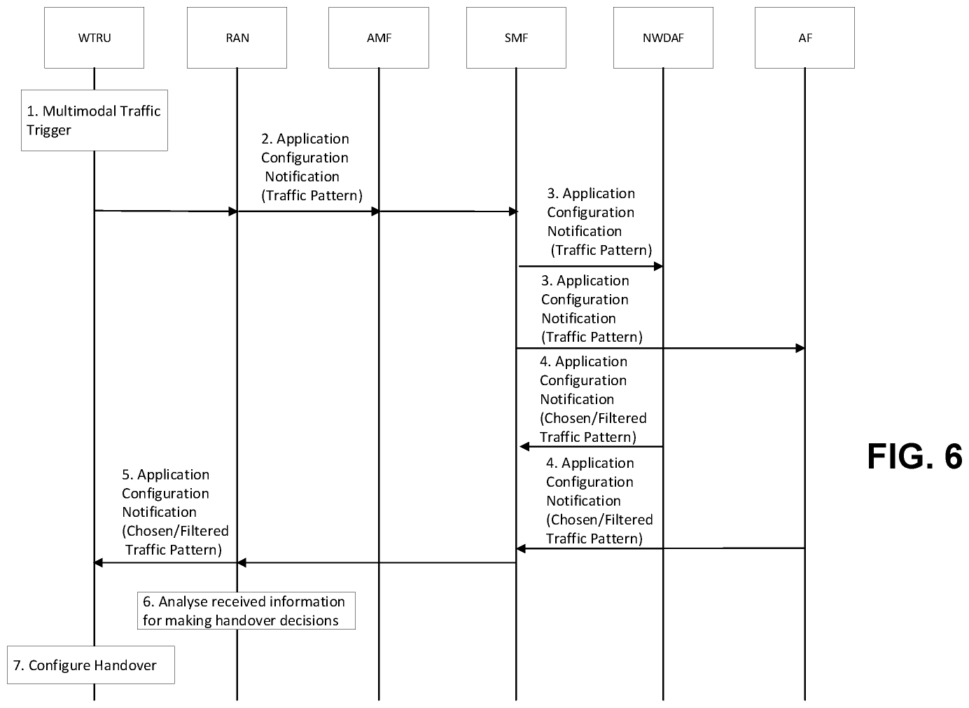

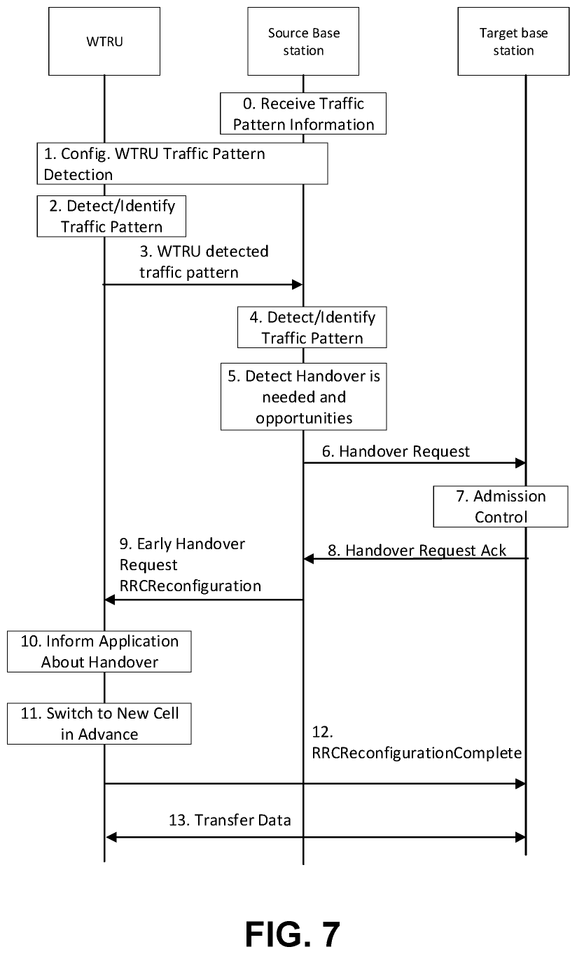

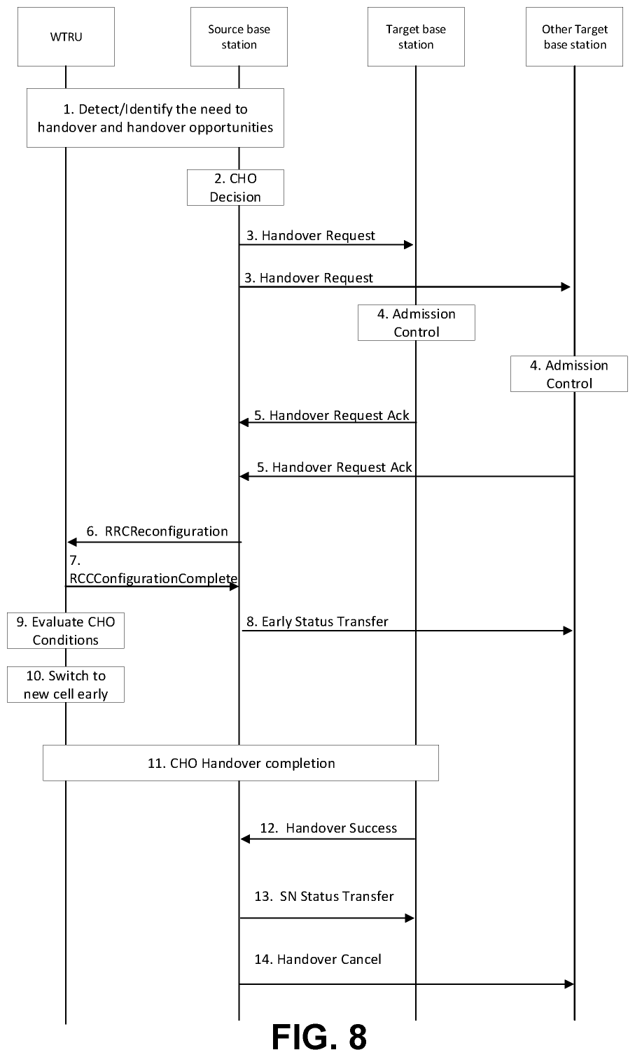

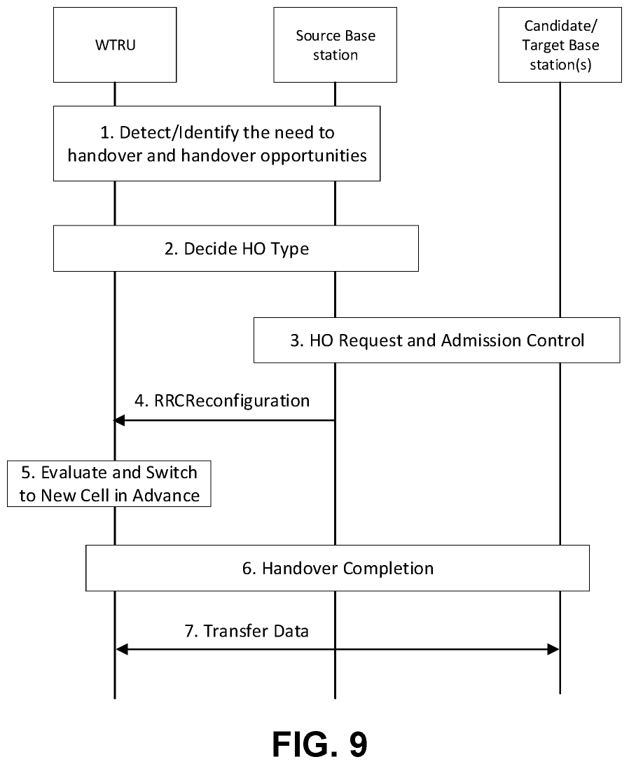

FIG. 5 and FIG. 6 illustrate examples of operations associated with reception of traffic pattern information by a network device (e.g., a RAN device). FIG. 7 and FIG. 8 illustrate examples of operations associated with notifying a network device (e.g. a RAN device) about what traffic pattern may be in use at a WTRU. As shown in these figures, the network device may use the received information (e.g., an indication of what traffic pattern may be in use at the WTRU) to plan whether and/or when to perform a handover. An application layer at the WTRU and/or in an application function (AF) may be informed about the handover (e.g., which may be an imminent handover) such that the WTRU and/or the AF may adapt or execute a task at the application layer in preparation for the handover. FIG. 9 illustrates an example of determining which type of handover (e.g., a normal HO or a DAPS-based HO) may be applied based on information received from a WTRU (e.g., traffic pattern related information that may indicate the priority of a data flow, PDU packet, PDU set, or PDU data).

A WTRU and/or a network may receive traffic pattern information. Such traffic pattern information may include one or more traffic characteristics associated with an application or derived by an application. The traffic pattern information may be used for identifying a suitable time for performing a handover, for example, to avoid delays or disruptions to an application experience. The traffic pattern information may indicate (but not limited to) a periodicity of data transmissions or receptions, a transmission or reception gap (e.g., when no data may be transmitted or received), traffic profile information, a group of picture (GOP) structure, PDU set or PDU group related information, etc.

The traffic pattern information may indicate a priority, type, or importance level of the data being transferred. The traffic pattern information may indicate synchronization related information and/or information about non-data traffic (e.g., XR monitoring packets estimating latency). The traffic pattern information may be specified at various levels including, but not limited to, a priority at a stream or flow level, a priority at a packet level, a priority at a PDU level, a priority at a PDU set level, and/or a priority at a data level. The traffic pattern information may indicate whether certain DL traffic is triggered by previously transmitted UL traffic (e.g., UL data about a user's pose change may trigger multimodal traffic in the DL). Such an indication may be used by a network device (e.g., a base station) to arrange for a handover to occur after the UL and DL traffic has been transferred, or after (e.g., immediately after) the UL traffic has been sent (e.g., while addressing photon-to-motion, motion-to-proton, and/or photon-to-sound requirements, wherein motion may refer to the movement of a user and photon may refer to visual effects resulting from the movement).

A priority related parameter may be used to advance (or delay) a handover, such that the handover may be scheduled or planned to reduce or minimize delays to high priority data. For example, traffic pattern information transmitted by a WTRU to a network device may indicate that a PDU that includes a certain identifier value (e.g., a marker) in the PDU header may have a particular priority or importance level. The priority of traffic may also be used to determine when to send the traffic to a source base station and a target base station in parallel.

Other information may be transferred together with traffic pattern information. Such information may include, for example, handover traffic rules, which may specify associations between packet filtering information such as associations between a PDU set priority, specific bits of a PDU set sequence number, a PDU set first or last packet flag, an XR application session ID, an XR application session priority, an XR flow ID, an XR flow priority, a data type (e.g., audio, video, etc.), an XR synchronization group ID, a 5-tuple, etc. Such information may also include one or more handover related information elements (IEs), such as, e.g., a preferred handover type and/or a handover policy. The handover policy may indicate how to treat data based on an XR flow priority. For example, a handover policy may specify how data may be transferred based on assigned priority levels. The handover policy may specify how priorities may be handled. For example, the policy may specify that a WTRU may send high priority flows before a handover (HO) operation, or that the WTRU may send high priority flows if a certain parameter reaches a specified value (e.g., x %), or that the WTRU may send low priority flows after the completion of a handover. Artificial intelligence (AI) and/or machine learning (ML) services provided by a system (e.g., a network data analytics function (NWDAF) may be used to improve existing traffic patterns (e.g., identify optimal times to perform handover based on traffic patterns provided). In examples (e.g., where a WTRU or AF sends minimal or no traffic pattern information to a network device), AI/ML may be used for learning and/or identifying traffic patterns and/or suitable (e.g., most suitable) conditions for performing a handover. The AI/ML may learn from information and/or feedback gathered by the WTRU and/or the network.

FIG. 5 illustrates example procedures associated with a base station receiving traffic pattern related information (e.g., configuration information) from an AF. FIG. 6 illustrates example procedures associated with a base station receiving traffic pattern related information (e.g., configuration information) from a WTRU.

As shown in FIG. 5, at 1, an event may trigger the AF to create or modify information related to multi-modal or XRM traffic that the network may serve for a given multi-modal or XRM session. For example, the creation of a multi-modal or XRM session may trigger the network to renew the traffic pattern information it may have stored.

At 2, the AF may invoke an NEF API to provide traffic pattern related information to the communication system. The AF may provide more than one traffic pattern. The AF may specify the session, flow, PDU (e.g., PDU set), or data that the traffic patterns may be related to. The session may be specified, for example, by an IP 4-tuple, a subscription permanent identifier (SUPI), a generic public subscription identifier (GPSI), or a data network name (DNN)/single-network slice selection assistance information (S-NSSAI) combination. The related information may include measurement configurations (e.g., thresholds and/or triggers for sending measurement reports to the RAN), parameters for handover (e.g., timers to allow early or late measurement reports), list of preferred cells for performing handover, etc.

At 3a, the NEF may use the session information received at 2 to query a binding support function (BSF) and determine what PCF may serve the XRM session. The NEF may forward the traffic pattern information to the PCF, e.g., in an application configuration notification. The PCF may use the traffic pattern information to derive PCC rules for the XRM session. The PCF may send the PCC rules and traffic pattern information to the SMF, e.g., in an application configuration notification.

At 3b (e.g., as an alternative to step 3a), the NEF may use the session information received at 2 to query a BSF and determine what PCF may serve the XRM session. The NEF may notify the PCF that the NWDAF may be able to provide traffic pattern information for the XRM session. The NEF may forward the traffic pattern information to the NWDAF, for example, via an application configuration notification. The NWDAF may use the traffic pattern information and/or other collected analytics (e.g., collected from the AMF, SMF, or UPF) to determine what traffic patterns the WTRU may use. The SMF may subscribe the NWDAF to be notified if the NWDAF derives new traffic pattern information, and the NWDAF may forward the determined traffic pattern information to the SMF, for example, via an application configuration notification.

At 4, the SMF may store the received traffic pattern information and may use it to derive QoS rules (e.g., new QoS rules). The QoS rules and/or the traffic pattern information may be forwarded to the RAN, e.g., via the AMF and/or in an N2 Message. The traffic pattern may include or be included as part of the QoS rules. The SMF may send the traffic pattern information and/or QoS rules to the WTRU, e.g., via the AMF and/or through N1 (NAS) signaling.

At 5, the WTRU may receive the traffic pattern information and/or related information from the RAN, e.g., in an application configuration notification (e.g., an RRC message). The RAN may filter and/or forward a subset (e.g., only a subset) of the traffic pattern information and/or related information to the WTRU. The related information may include measurement configurations (e.g., new thresholds and/or triggers for sending measurement reports to the RAN), parameters associated with handover (e.g., timers to allow early or late measurement reports), a list of preferred cells for performing handover, etc.

At 6, the WTRU may respond to the RRC message received at 5. In the response, the WTRU may indicate a determined (or chosen) traffic pattern and/or related information that may be used (e.g., by the network) to perform a handover. The WTRU may send the response to a network device via an application configuration notification. At 7, the RAN may use the information obtained at 4 and/or 6 to determine what traffic pattern(s) may be used by the WTRU, and the RAN may use this information to determine the timing of handover events.

FIG. 6 illustrates an example of receiving traffic pattern Information from a WTRU that may be associated with performing a handover.

At 1, an application hosted on the WTRU may trigger the updating of multi-modal and/or XRM traffic related information in the network (e.g., a RAN device such as a base station). For example, the establishment of a PDU session for multi-modal and/or XRM traffic may trigger the WTRU to send multi-modal and/or XRM traffic related information to the network. The reception of an application layer message with configuration or traffic pattern information may trigger the WTRU to send multi-modal and/or XRM traffic related information to the network.

At 2, the WTRU may send traffic pattern information associated with the application and/or its related information to the RAN network (e.g., a base station) and/or to a core network (e.g., to an SMF via an AMF). The WTRU may send the information, for example, via an application configuration notification. The information sent to the AMF and/or the SMF may be carried in one or more N1 (NAS) messages. The information sent to the SMF may be carried within an NAS-SM container. The information sent to the RAN may be sent in an RRC message. One or more of the messages described herein may include the ID of the multi-modal and/or XRM traffic session (e.g., a PDU session ID), and/or any other identifiers that may identify the application and/or data being transferred. Such message(s) may indicate to the network what traffic pattern(s) the WTRU may or may expect to use. The message(s) may indicate to the network what traffic pattern(s) the WTRU may be using currently.

At 3, the SMF may send information related to traffic patterns to the NWDAF, e.g., in an application configuration notification. The NWDAF may optimize the received traffic patterns and/or related information. The SMF may send information related to traffic patterns to the AF, e.g., in an (e.g., another) application configuration notification. The AF may store this information, e.g., to be used later.

At 4, the NWDAF and/or AF may filter received traffic patterns and/or related information and may send the chosen (e.g., best suited) patterns to the SMF (e.g., in an application configuration notification) to be sent to the RAN and the WTRU. The NWDAF may respond with newly generated or improved version of traffic patterns and/or related information.

At 5, the SMF may send filtered or chosen traffic patterns and/or related information to the RAN and the WTRU separately, e.g., via application configuration notifications. The SMF may send such traffic patterns and/or related information to the RAN and the RAN may forward the traffic patterns and/or information to the WTRU, e.g., after further processing the traffic patterns and/or related information (e.g., further filtering based on a handover type).

At 6, the RAN may use the information obtained at 2 and/or 5 to determine what traffic patterns may be in use by the WTRU and the RAN may use this information to determine the timing of handover events. At 7, the WTRU may use the traffic pattern information to configure handover events as described herein.

A handover may be planned. Network-controlled and/or WTRU-controlled handover procedures such as CHO procedures may be enhanced to consider multi-modal or XRM traffic patterns when executing the handover procedures.

FIG. 7 illustrates an example of an advance handover that may be performed based on XR traffic patterns. As shown in FIG. 7, the RAN may, at 0, receive traffic pattern information as described herein. At 1, a source base station may configure WTRU measurements (e.g., measurement procedures) and the WTRU may report what traffic patterns may be in use according to the configuration. The RAN (e.g., a source base station) may configure the WTRU to detect or identify traffic patterns for a specific session. The configuration information may include information received at 0 by the RAN. The configuration may include an ID that uniquely identifies a multi-modal session. Preexisting information of traffic patterns (e.g., which may be gathered through learning) may be provided to the RAN and/or WTRU. The WTRU may receive one or more pieces of information from (e.g., directly from) a corresponding AF or AS. The WTRU may be configured by the source base station with one or more handover (HO) modes and/or parameters associated with the HO modes that may be supported or allowed by the RAN. Such handover modes may include normal HO, CHO, DAPS, or any other HO procedure that may support an HO associated with multi-modal traffic.

At 2, the WTRU may analyze the application traffic (e.g., UL traffic or DL traffic) to identify a traffic pattern (e.g., in the UL or DL). This operation may be triggered by the message sent by the RAN at 1. The WTRU may start the operation (e.g., automatically) based on pre-configured configurations on the WTRU, e.g., without receiving the message at 1. For example, the WTRU may start to monitor and analyze traffic when a multi-modal or XR session has been established.

At 3, the WTRU may inform (e.g., send an indication to) the RAN about a detected or identified traffic pattern. The indication may be sent in an indication message and may indicate the determined traffic pattern. This indication message may include information about the specific traffic pattern detected or identified. In certain examples, the indication message may inform the RAN of the WTRU's preferred method of performing a handover (e.g., normal handover, CHO, DAPS, etc.).

At 4, the RAN (e.g., the source base station) may analyze the traffic pattern indicated by the WTRU (e.g., related to application traffic) to identify the traffic pattern (e.g., in the DL). This operation may be performed sequentially to other operations described herein, or in parallel to those operations (e.g., the operations at 1-3 of FIG. 7). In examples, a traffic analysis for pattern recognition may be performed (e.g., solely) by the RAN, in which case the operation at 4 may be started at the time a multi-modal or XR session is established. In examples, traffic pattern detection or identification may be performed by the UPF and the UPF may communicate the result to the RAN.

At 5, the RAN (e.g., the source base station) may determine that a handover may be performed, for example, based on measurement information related to the connection between the RAN and the WTRU. Based on information gathered about the traffic pattern at the WTRU, the RAN (or the UPF) may determine whether there are opportunities for performing the handover in advance (of certain application traffic at the WTRU).

At 6, the source base station may send a handover request to a target base station, e.g., over an Xn interface. At 7, the target base station may perform admission control. At 8, the target base station may acknowledge the handover request and/or may respond to the source base station with an RRC configuration and/or a handover request acknowledgment.

At 9, the WTRU may receive a handover related message such as an reconfiguration (e.g., RRCReconfiguration) message from the RAN, which may indicate the possibility and/or a manner (e.g., time, trigger, condition, etc.) for performing a handover (e.g., early or in advance of certain application traffic). This message may include information about when and/or how the handover may be performed. A first type of information that may be included in the message may refer to certain traffic characteristics. For example, such information may indicate that the handover may be advanced based on the priority of traffic (e.g., the information may indicate that the handover may be advanced to occur before receiving traffic of a certain priority, or before transmitting traffic of a certain priority). The information may indicate that the timing of the handover may be controlled (e.g., advanced) based on a marker in a PDU header. For example, the information may indicate that the handover may be advanced to occur before sending traffic that may have this marker, after receiving traffic that may have this marker, or after sending traffic that may have this marker. A second type of information that may be included in the message received from the RAN may refer to specific temporal information (e.g., specific time intervals) associated with performing the handover (e.g., the information may indicate that the handover may be performed during a transmission or reception gap of application traffic). A third type of information that may be included in the message received from the RAN may refer to traffic quantity. For example, such information may indicate that the handover may be advanced to occur after the WTRU has received K DL PDUs, or after the WTRU has transmitted K UL PDUs. The message received from the RAN may include one or more sets of threshold values for triggering the handover. These threshold values may be chosen based on a traffic type.

In some scenarios, a message indicating the possibility of a handover may be sent to the relevant AF and/or AS(s), so that the AF and/or as(s) may decide whether to perform any relevant application layer operations.

At 10, the WTRU may inform an application about a handover (e.g., an imminent handover) so that decisions on relevant application layer adjustments may be made (e.g., regarding whether or not to change a video codec due to connection disruptions while performing the handover). The WTRU application may be informed that a handover event has occurred or may be imminent. The WTRU application may use this information to determine how and/or whether to adjust application settings (e.g., codec settings). For example, the WTRU application may normally determine to adjust a codec setting, such as a frame rate, when a number of packets are dropped or received in error, and the WTRU application may choose to forgo such a setting change if a handover has occurred or may be imminent. This may be because the WTRU application may assume that the packets were dropped due to a transient event such as the handover.

At 11, the WTRU may perform the handover based on the message received from the RAN (e.g., base station). For example, the WTRU may perform the handover if the WTRU is not receiving or sending critical data (e.g., high priority data). The WTRU may perform the handover during a specific time period. For example, the WTRU may identify the start and/or end of a data burst and perform the handover at the end of the data burst.

At 12, the WTRU may send a message such as an RCCReconfigurationComplete message to the target base station, for example, once the WTRU moves the RRC connection to the target base station. In some examples, the WTRU may include a reason and/or condition of the handover in the message (e.g., indicating that the handover is performed because of a certain threshold value set has been chosen). At 13, the WTRU may transmit data to or receive data from the target base station. The data may include data (e.g., high priority data) that may have been held or buffered at the WTRU or the RAN, or both, before the handover.

FIG. 8 illustrates an example of a conditional handover that may be performed based on XR traffic patterns. At 1, operations similar to those described with respect to 0-5 of FIG. 7 may be performed. The WTRU may inform a source base station about a preference to use a CHO, along with a reason for the preference (e.g., CHO may be preferred due to latency requirements of a haptic flow in the UL). This information may be used by the source base station to decide whether to apply the CHO.

At 2, the source base station may decide to use the CHO based on information associated with traffic patterns (e.g., which may be provided by the WTRU). For example, the source base station may decide to perform the CHO (e.g., instead of a normal handover) due to strict latency requirements of some flows of a multimodal session.

At 3, the source base station may select one or more candidate cells that may belong to one more candidate target base stations, and may send a handover request message regarding the CHO. This message may include multi-modal or XRM session related information (e.g., session ID, required services, etc.), and/or information about flows and/or their requirements (e.g., the multi-modal or XRM session may include a haptic flow with URLLC requirements).

At 4, one or more candidate target base stations may perform admission control over the handover request. The admission control may be a multi-modal or XR session aware admission control, e.g., if multi-modal or XR session aware information is sent to the target base station(s). At 5, the target base station(s) may prepare for the handover and send a handover request acknowledgment message to the source base station. This message may indicate whether the base station supports multi-modal or XR sessions and/or services. The message may indicate one or more restrictions or rules for performing a handover for multi-modal or XR sessions and/or services. Such restrictions or rules may include a validity time window (e.g. start time, end time, duration, etc.), which may indicate when handover may be performed.

At 6, the WTRU may receive from the source base station a message such as an RRC message (e.g., an RRCReconfiguration message or a handover command) that may include configuration information regarding CHO candidate cell(s) and/or CHO execution condition(s). The CHO execution conditions may include traffic pattern information and/or traffic priority information that may be used for deciding when to perform the CHO. The CHO execution conditions may include radio link measurements threshold values associated with a radio link between the WTRU and a candidate cell. This message may indicate the possibility for performing the handover early (e.g., in advance of certain data transmission or reception at the WTRU). This message may specify information on when the handover may be performed, which may be based on the priority of traffic. For example, the message may indicate that the handover may be advanced to occur before receiving traffic of a certain priority, or before transmitting traffic of a certain priority. The handover may be advanced based on a marker (e.g., a certain data element) in a PDU header. For example, the handover may be advanced to occur before sending traffic that may have this marker, after receiving traffic that may have this marker, or after sending traffic that may have this marker. The message from the source base station may refer to specific temporal information (e.g., specific time intervals such as transmission or reception gaps with no or little data flow) for performing the handover. The message from the source base station may refer to a traffic quantity for determining when to perform the handover. For example, the handover may be advanced to occur after the WTRU has received K DL PDUs, or after the WTRU has transmitted K UL PDUs (e.g., the value of K may be configurable). The message from the source base station may include one or more sets of threshold values for triggering the handover. These threshold values may be chosen based on a traffic type.

The WTRU may inform an application (e.g., which may be running on the WTRU or a remote server) about the handover (e.g., which may be imminent) so that relevant application layer adjustments may be made in anticipation of the handover (e.g., decide whether or not to change a video codec due to potential connection disruptions when performing the handover). In some scenarios, a message indicating the possibility of the handover may be sent to a relevant AF and/or AS, so that the AF and/or AS may decide whether to perform certain application layer operations in anticipation of the handover. Such a message may include, for example, multiple (e.g., 2) sets of measurement thresholds. A first set of measurement thresholds (e.g., a soft HO conditions set) may indicate when the HO may be performed, for example, to allow the WTRU to make a decision about whether to perform the handover (e.g., based on XR traffic patterns). A second set of measurement thresholds (e.g., a hard HO conditions set) may indicate that the WTRU is to perform the HO and/or when to perform the HO.

At 7, the WTRU may send an RRC response message (e.g., an RRCReconfigurationComplete message) to the source base station. This message may include one or more configurations chosen from those received at 6 (e.g., the threshold values for performing the handover). At 8, if early data forwarding is applied, the source base station may send a message to indicate an early status transfer. This message may include information related to an XRM session (e.g., ID), information related to a PDU set (e.g., PDU set ID), and/or multi-modal synchronization and/or correlation information (e.g., a multi-modal session correlation ID) that may indicate inter-dependency between PDUs, flows, and/or sessions.

At 9, the WTRU may start evaluating traffic patterns and/or the CHO execution conditions associated with the candidate target cell(s). The WTRU may take information from a layer (e.g., an application layer, a PDU, a PDU set, a packet, or a data layer). The WTRU may analyze the traffic and determine if the CHO may be performed (e.g., before transferring high priority traffic). The WTRU may also determine if there is a time period during which traffic may not be transmitted or received (e.g., so that the time period may be used for performing the CHO). The WTRU may also determine if there may be traffic that should be sent before performing the CHO.

At 10, if a CHO candidate cell satisfies the corresponding CHO execution conditions (e.g., soft HO conditions), or if traffic characteristics satisfy specified conditions, the WTRU may release the connection from the source cell before sending an RACH or RRC message to the target cell. The WTRU may also maintain connections with both the source base station and the target base station, and continue traffic transmission from both cells, before detaching from the source base station. The connection to the source cell may be released if the WTRU receives a confirmation from the target cell (e.g., confirming that resources are allocated to satisfy requirements of the flows). The WTRU may perform the handover during a specific time period. For example, the WTRU may identify the start and end of a data burst and perform the handover at the end of the data burst). If hard CHO execution conditions are specified and the corresponding conditions are met, the WTRU may ignore the soft handover conditions.

At 11, the WTRU may synchronize with the selected target cell and complete the handover procedure, for example, by sending a message such as an RRCReconfigurationComplete message to the target base station. This message may include information related to an XRM session (e.g., a session ID), information related to a PDU set (e.g., a PDU set ID), and/or multi-modal synchronization/correlation information (e.g., a multi-modal session correlation ID) that may indicate inter-dependency between PDUs, flows, and/or sessions.

At 12, the target base station may send a handover success message to the source base station informing the source base station that the WTRU has successfully accessed the target cell. At 13, the source base station may send an SN status transfer message to the target base station. At 14, the source base station may send a handover cancel message to one or more (e.g., all) target base stations, cancelling CHO for the WTRU.

A handover type such as a protected handover may be created for XRM traffic. Such a protected handover (HO) may be used to maintain delay and/or reliability requirements during the transmission of critical data. The protected HO may be used to achieve low traffic delay and/or high traffic reliability. The protected HO may be a DAPS handover, a CHO, a combination of DAPS HO and CHO, an enhancement to these handover types, or a new handover type. When performed, the protected HO may cause a WTRU to change from a source cell to a target cell, or remain in the source cell. In some examples provided herein, an enhanced DAPS HO type may be treated or referred to as a protected handover, but protected handovers may also include other types of handovers.

In examples, a WTRU may make a request for an enhanced DAPS HO. The WTRU may send an indication (e.g., an explicit indication) regarding the enhanced DAPS HO to a RAN node (e.g., a base station) based on one or a combination of the following: the WTRU's knowledge of upcoming downlink traffic, the WTRU's knowledge of uplink traffic to transmit, the WTRU's knowledge of upcoming traffic on a DRB that may have high reliability and/or low delay requirements, the WTRU's knowledge of poor radio conditions in the source cell, or the WTRU's knowledge of better radio conditions in a target cell. The indication may include a reason for the enhanced DAPS HO request and/or a time indication. As an example of the time indication, the HO request may include a start time and an end time for the HO. As another example of the time indication, the HO request may include a start time and a duration for the HO. As yet another example of the time indication, the request may include only a start time for the HO, in which case the WTRU may explicitly signal to the base station if the enhanced DAPS HO is no longer needed. As yet another example of the time indication, the HO request may include only an end time for the HO.

In examples, a WTRU measurement configuration may include one or more thresholds for triggering an enhanced DAPS HO. A first threshold (e.g., Threshold1) may trigger the WTRU to send a first measurement report to a RAN node (e.g., a base station) indicating that radio conditions of the source cell may be deteriorating, or that radio conditions in a target cell may be more satisfactory, or some combination of radio conditions in the source cell or target cell. This first measurement report may be used by the RAN node to start the enhanced DAPS HO. A second threshold (e.g., Threshold2) may trigger the WTRU to send a second measurement report to the RAN node. This second measurement report may help the RAN node determine whether to hand the WTRU over to the target cell from the source cell, or to keep the WTRU in the source cell.

In response to receiving an explicit indication or measurement report from the WTRU, the RAN may configure the WTRU with an enhanced DAPS HO. The WTRU may rely on DAPS to synchronize to the target cell and complete the DAPS HO configuration. After attaching to the target cell, the WTRU may or may not detach from the source cell. For example, the WTRU may maintain an attachment to both the source base station and the target base station until one or more of the following occur.

The WTRU may maintain the attachment to both the source base station and the target base station until the enhanced DAPS HO is no longer desired. For example, the WTRU may have transmitted and/or received the traffic associated with a protected HO. For the remaining traffic, the WTRU may return to using a legacy HO procedure. In such cases, the WTRU may send a release message (e.g., an explicit release message) to the source RAN node, or the target RAN node, or both RAN nodes. In the message, the WTRU may indicate the RAN node with which the WTRU may prefer to maintain a connection after the enhanced DAPS HO is terminated.

The WTRU may maintain the attachment to both the source base station and the target base station until the WTRU receives an explicit release from the source node. In such cases, the release message may indicate the node with which the network may prefer to maintain a connection after the enhanced DAPS HO is terminated.

The WTRU may maintain the attachment to both the source base station and the target base station until the WTRU receives an explicit release from the target node. In such cases, the release message may indicate the node with which the network may prefer to maintain a connection after the enhanced DAPS HO is terminated.

The WTRU may maintain the attachment to both the source base station and the target base station until a certain time period expires (e.g., based on a timer maintained by the WTRU). For example, the WTRU may be configured with a duration for the enhanced DAPS HO, and/or an indication of which node the WTRU may fall back to, after the enhanced DAPS HO is terminated. The WTRU may maintain the enhanced DAPS HO until the duration expires. After that, the WTRU may detach from a first network node and switch to a second network node. The choice of these nodes may be included in a configuration message. For example, at the expiration of the time period or duration (e.g., based on a timer), the WTRU may use the source RAN node and detach from the target RAN node. The choice of these nodes may be based on default behaviors. For example, the WTRU may be configured to choose (e.g., always choose) the source RAN node for maintaining a connection. The choice of these nodes may be based on measurements. For example, the WTRU may choose to maintain a connection with a RAN node that has better radio conditions.

A handover type may be selected based on traffic characteristics. The traffic characteristics may include information that may be related to and/or describe the characteristics of communications with an application (e.g., traffic patterns). Such information may be used to enhance a handover while minimizing its negative impact on the user experience. Such information may be used for identifying a suitable time for performing the handover, and/or for identifying the type of handover to use (e.g., a handover performed during high priority data transmission may use DAPS, while a conventional HO may be used for other traffic). When referred to herein, traffic patterns or traffic pattern information may include traffic periodicity information, traffic profile information, a group of picture (GOP) structure, a PDU priority, a PDU set/group priority, and/or the like. Using such information, a handover may be planned to reduce or minimize delays to high priority data and/or disruptions to the overall user experience.

FIG. 9 illustrates an example of handover type selection. At 1, one or more operations described with respect to 0-5 of FIG. 7 may be performed. A WTRU may inform a network device such as a source base station about a preference for a specific handover type or mode (e.g., CHO, DAPS, normal handover, etc.) and/or a reason for the preference (e.g., CHO may be preferred based on latency requirements of a haptic flow in the UL). The WTRU may provide a list of preferred or supported handover types to the source base station, for example, with a ranking from the most desirable HO type to the least desirable HO type. This information may be used by the source base station to decide which handover types or modes may be applied.

At 2, the source base station and/or the WTRU may decide the type of HO (e.g., normal HO, CHO, DAPS, etc.) to be performed (e.g., the RAN may consider the WTRU's preference or decision before making a final HO decision). The decision may be made based on traffic characteristics (e.g., traffic patterns including the importance or priority of traffic). For example, if a large amount of high priority data is to be transferred (e.g., as indicated by a traffic pattern reported/indicated by the WTRU), the source base station may decide to use DAPS to minimize delays. Traffic filter information (e.g., information associated with the filtering of packets based on certain criteria) as described herein may be used to facilitate the decision-making.

At 3, depending on the type of handover procedures that may be chosen, the source base station may trigger admission control in one or more candidate target cells, e.g., by sending a handover request message to the candidate target base station(s). If the request passes the admission control, the source base station may receive a handover request acknowledgment message. This message may include multi-modal or XRM session related information (e.g., a session ID, required services, etc.), and/or information about flows and their requirements (e.g., a session may include a haptic flow requiring URLLC). This operation may include one or more (e.g., any) DAPS procedures defined for handover requests, admission control, and/or handover request acknowledgment.

At 4, the WTRU may receive, from the source base station, a message such as an RRCReconfiguration message. This message may specify a chosen handover type and/or its configurations. In case a CHO is used, the message may include the configuration of CHO candidate cell(s) and/or CHO execution condition(s). The CHO execution conditions may include traffic pattern information and/or traffic priority information to be used for deciding when to perform the CHO. In case DAPS is used, the message may include configuration information associated with the DAPS. The message may indicate the possibility or request for performing the handover early (e.g., in advance of certain data transmission or reception). The message may include information on when the handover may be performed, which may refer to certain traffic characteristics (e.g., before transmitting or receiving a PDU with a specific marker) and/or temporal positions (e.g., specific time intervals such as transmission or reception gaps). The message may include one or more sets of threshold values that may trigger the handover. The threshold values may be chosen based on traffic types. The WTRU may inform an application about the handover (e.g., which may be imminent) so that decisions on relevant application layer adjustments may be made (e.g., decide whether or not to change a video codec due to potential connection disruptions when performing the handover). In some scenarios, a message indicating the possibility of the handover may be sent to a relevant AF and/or AS so that the AF and/or AS may decide whether to perform certain application layer operations in anticipation of the handover.

At 5, the handover may be performed in advance, for example, before sending data identified as having a high priority. The WTRU may (e.g., if a DAPS handover is used) continue uplink and/or downlink user data transmission from the source base station until a connection to the source cell is released and/or a random access procedure to the target base station is successfully performed. If a CHO is used, the WTRU may evaluate traffic conditions associated with the CHO. If a CHO candidate cell satisfies the corresponding CHO execution conditions, and/or if traffic characteristics satisfy the traffic conditions, the WTRU may detach from the source base station and apply stored configuration for the target cell. The WTRU may perform the handover during a specific time period (e.g., the WTRU may identify the start and end of a data burst and perform the handover at the end of the data burst). The priority of traffic may be considered when deciding whether to transmit or receive the traffic. For example, an HO traffic rule may specify that flows with a certain priority should be sent using DAPS. As another example, traffic (e.g., PDU sets) with certain marking (e.g., as specified by HO traffic rules) such as traffic with an HO type of “DAPS preferred” and/or an HO policy of “high priority over DAPS” may be sent before the handover, while other types of traffic (e.g., one or more PDU sets without the marking) may be dropped or held for the HO to be complete.

In some scenarios, handover types may be selected based on subsets of traffic that may be on-going around the time of a handover. For example, for a first subset of traffic (e.g., a first subset of PDUs), the handover may be performed using DAPS, while for a second subset of traffic (e.g., a second subset of PDUs), the handover may be performed as a normal HO (e.g., not using DAPS).

At 6, the WTRU and base station(s) may complete the handover by performing a handover completion procedure (e.g., by sending an RRC reconfiguration complete message, a handover success message, and/or a path switch request) based on the type of handover being used. At 7, the high priority data identified may be sent.

In at least some of the scenarios described herein, an application such as an application on the WTRU or an AF may adapt or adjust certain application procedures based on knowledge that there may be disruptions to application services due to an ongoing handover process. The adjustments may be made upon deciding to perform the handover or receiving an instruction or indication to perform the handover (e.g., via an RRCReconfiguration message). For example, due to potential disruptions to the connectivity or a reduced bandwidth during the handover, the application may decide to change a video codec, even though the connectivity may be restored after the handover. Such changes may be avoided if the application is made aware of an imminent handover procedure (e.g., via lower layer signaling) based on the techniques disclosed herein.

At least some of the procedures described herein may allow a handover to be performed in advance (e.g., perform the handover before sending data with high priority/importance and/or stringent requirements) to minimize delays to traffic with stringent delay requirements. In at least some of the procedures described herein, a handover may be delayed, for example, until data with high importance/priority and/or stringent requirements are sent (e.g., data may be sent before the handover is performed). For example, at 9 of FIG. 7, the source base station may send an RRCReconfiguration message to the WTRU, indicating the possibility of performing the handover late, and/or specifying an amount (e.g., a maximum amount) of time that the handover may be delayed by. In scenarios where high priority traffic (e.g., flows, PDUs, PDU sets, data, etc.) may be prioritized over low priority traffic, and/or where a choice may be made between sending low priority traffic and sending high priority traffic, the high priority traffic may be sent before the low priority traffic. In some cases, the low priority traffic may be dropped.

Although features and elements described above are described in particular combinations, each feature or element may be used alone without the other features and elements of the preferred embodiments, or in various combinations with or without other features and elements. Although the implementations described herein may consider specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1. A wireless transmit/receive unit (WTRU), comprising:
a processor configured to:
determine a traffic pattern associated with the WTRU, wherein the traffic pattern is associated with uplink traffic or downlink traffic, and wherein the traffic pattern indicates at least a timing or a priority of the uplink traffic or the downlink traffic;
send an indication of the traffic pattern to a network device;
receive a message from the network device regarding a handover, wherein the message indicates a manner for performing the handover; and
perform the handover in the manner indicated by the message received from the network device, wherein the handover is performed in accordance with the timing or the priority of the uplink traffic or the downlink traffic.

2. The WTRU of claim 1, wherein the manner for performing the handover indicates a time, trigger, or constraint for performing the handover.

3. The WTRU of claim 1, wherein the indication of the traffic pattern indicates a priority of application data to be transmitted or received by the WTRU, and wherein the message received from the network device indicates that the handover is to be performed before the transmission or reception of the application data.

4. The WTRU of claim 1, wherein the message received from the network device indicates that the handover is to be performed before or after a transmission of a protocol data unit (PDU) that is associated with a marker, or after a reception of a PDU that is associated with the marker.

5. The WTRU of claim 16, wherein the indication of the traffic pattern indicates a periodicity of application data to be transmitted or received by the WTRU, and wherein the message received from the network device indicates that the handover is to be performed during a specific time interval associated with the application data.

6. The WTRU of claim 5, wherein the specific time interval includes a transmission or reception gap associated with the application data.

7. The WTRU of claim 1, wherein the message received from the network device indicates that the handover is to be performed after a specific amount of application data is transmitted or received by the WTRU.

8. The WTRU of claim 1, wherein the traffic pattern is associated with a multi-modal or extended reality application associated with the WTRU.

9. The WTRU of claim 16, wherein the processor is further configured to receive configuration information from the network device that indicates that the traffic pattern is to be determined by the WTRU with respect to one or more of a traffic type, an application, a multi-modal or extended reality session, or a quality of service (QoS) rule.

10. A method implemented by a wireless transmit/receive unit (WTRU), the method comprising:
determining a traffic pattern associated with the WTRU, wherein the traffic pattern is associated with uplink traffic or downlink traffic, and wherein the traffic pattern indicates at least a timing or a priority of the uplink traffic or the downlink traffic;
sending an indication of the traffic pattern to a network device;
receiving a message from the network device regarding a handover, wherein the message indicates a manner for performing the handover; and
performing the handover in the manner indicated by the message received from the network device, wherein the handover is performed in accordance with the timing or the priority of the uplink traffic or the downlink traffic.

11. The method of claim 10, wherein the indication of the traffic pattern indicates a priority of application data to be transmitted or received by the WTRU, and wherein the message received from the network device indicates that the handover is to be performed before the transmission or reception of the application data.

12. The method of claim 10, wherein the indication of the traffic pattern indicates a periodicity of application data to be transmitted or received by the WTRU, and wherein the message received from the network device indicates that the handover is to be performed during a specific time interval associated with the application data.

13. The method of claim 10, wherein the message received from the network device indicates that the handover is to be performed after transmission or reception of a specific amount of application data.

14. The method of claim 10, further comprising receiving configuration information from the network device, wherein the configuration information indicates that the traffic pattern is to be determined by the WTRU with respect to one or more of a traffic type, an application, a multi-modal or extended reality session, or a quality of service (QoS) rule.

15. A network device, comprising:
a processor configured to:
transmit configuration information to a wireless transmit receive unit (WTRU), wherein the configuration information includes an indication for the WTRU to perform traffic pattern detection;
receive a report from the WTRU, wherein the report indicates a traffic pattern associated with the WTRU;
determine, based on the traffic pattern indicated in the report, a manner for the WTRU to perform a handover; and
transmit a message to the WTRU, wherein the message indicates the manner for the WTRU to perform the handover.

16. The network device of claim 15, wherein the traffic pattern indicates a priority of application data to be transmitted or received by the WTRU, and wherein the message transmitted to the WTRU indicates that the handover is to be performed before the transmission or reception of the application data.

17. The network device of claim 15, wherein the traffic pattern indicates a periodicity of application data.

18. The method of claim 10, wherein the message received from the network device indicates that the handover is to be performed before or after a transmission of a protocol data unit (PDU) that is associated with a marker, or after a reception of a PDU that is associated with the marker.

19. The method of claim 10, wherein the specific time interval includes a transmission or reception gap associated with the application data.

20. The method of claim 10, wherein the traffic pattern is associated with a multi-modal or extended reality application.
